(19) United States
(12) Patent Application Publication
(10) Pub. No.: US 2011/0006035 A1
(43) Pub. Date: Jan. 13, 2011

(54) METHOD FOR MODIFYING SURFACE IN SELECTIVE AREAS AND METHOD FOR FORMING PATTERNS

(75) Inventors: SHANG-JR GWO, Hsin-Chu (TW); MENG-HSIEN LIN, Hsinchu (TW)

Correspondence Address: STOUT, UXA, BUYAN & MULLINS LLP, 4 VENTURE, SUITE 300, IRVINE, CA, 92618, US

(73) Assignee: NATIONAL TSING HUA UNIVERSITY, Hsinchu (TW)

(21) Appl. No.: 12/502,226

(22) Filed: Jul. 13, 2009

(51) Int. Cl. B44C 1/22

(52) U.S. Cl. 216/41

(57) ABSTRACT

A method for modifying a surface in selective areas and a method for forming patterns are described. A template is attached to a surface of a sample, and plasma is provided to selectively modify the surface by using the template as a mask. Consequently, a pattern consisting of a modified area and an unmodified area is formed on the surface of the sample.

### FIELD OF THE INVENTION

The present invention relates to a method for modifying a surface in selective areas and, more particularly, to a method of a plasma-induced modification in selective areas of a surface.

### DESCRIPTION OF THE PRIOR ART

Nanotechnology has been developed as a reliable technology for producing minimal components for enabling performance of very precise functions. For instance, the availability of nanolithography processes is important in the fields of photonics, electronics, and biotechnology. Among the available nanolithography processes, nanoimprint and soft lithography are two alternatives to conventional photolithography for enabling the manufacture of devices with micrometer, nanometer, or centimeter-sized features.

The first-mentioned nanoimprint method mechanically imprints nano-patterns of a rigid template to a specific soft polymer plate. The soft polymer plate is then hardened such that the nano-patterns are formed on its surface. On the other hand, soft lithography methods, such as the microcontact printing, use an elastomeric stamp as a template. The elastomeric stamp is coated with a specific material as the ink paste and then contacted with a substrate to convert patterns to the substrate. As an example, an elastomeric stamp coated with thiol in contact with a gold-electroplated substrate can form patterns having corrosion-resisted self-assembled monolayer (SAM).

Both nanoimprint and microcontact printing methods employ templates to convert patterns, which techniques can satisfy the needs of scalability, high throughput, and low cost; however, the integration of a large quantity of nanoscale objects into functional devices and structures can still be a challenge to be overcome. Many factors, such as varying or uneven flatness and pressing uniformity of the imprint machine, the separation step of the template, and characteristics of the polymer, may decrease the yield rate of a nanoimprint method. In addition, the ink paste used with a microcontact printing method must be limited to a material that can react with the surface of the substrate, and resolution may fall short of requirements due to the diffusion of the applied inks.

Therefore, it would be advantageous to provide a novel nanolithography process having superior process capability and resolution.

### SUMMARY OF THE INVENTION

One object of the present invention entails the provision of a method for modifying a surface in selective areas and a method for forming patterns, whereby patterns comprising a modified area and an unmodified area are formed on the surface of a sample. The modified area and the unmodified area may have different properties and may interact with a specific substance, a biological molecule, or a metal particle.

Another object of the present invention is to provide a method for modifying a surface in selective areas and a method for forming patterns, thereby forming nanoscale or microscale patterns with small feature sizes and high resolution that can be used to produce minimized components to perform more precise functions.

Another object of the present invention is to provide a method for modifying a surface in selective areas and a method for forming patterns, thereby satisfying needs for producing components having different scales.

Another object of the present invention is to provide a method for modifying a surface in selective areas and a method for forming patterns, which can be carried out in a sample having a large area, thereby reducing the time and cost of pattern conversion.

Another object of the present invention is to provide a method for modifying a surface in selective areas and a method for forming patterns, which can be carried out in a sample without perfect flatness, thereby improving the process capability and protecting the sample from being damaged during the process.

Another object of the present invention is to provide a method for modifying a surface in selective areas and a method for forming patterns, which forms patterns of superior uniformity, selectivity, and resolution in combination with self-assembly technology. According to the objects, an embodiment of the present invention provides a method for modifying a surface in selective areas, comprising providing a sample having a surface, providing and attaching a template to the surface, and providing a plasma to contact and modify the selective areas of the surface by using the template to selectively isolate the plasma.

According to the objects, another embodiment of the present invention provides a method for forming patterns, comprising providing a sample, providing an elastic stamp having a relief structure and attaching it to a surface of the sample, and providing a plasma to selectively contact and modify the surface by using the elastic stamp to selectively isolate the plasma, thereby forming a modified area and an unmodified area on the surface wherein the plasma flows through the relief structure and modifies the surface, thus forming the modified area to comprise patterns of the relief structure.

According to the objects, yet another embodiment of the present invention provides a method for forming patterns, comprising providing a sample, providing an elastic stamp having a relief structure, the elastic stamp being attached to a surface of the sample, providing a plasma to selectively contact and modify the surface using the elastic stamp to selectively isolate the plasma thereby forming a modified area and an unmodified area on the surface, providing a self-assembled molecule to selectively interact with a specific area of the surface of the sample, and immersing the sample in a solution containing a substance, the substance selectively interacting with the self-assembled molecule.

### BRIEF DESCRIPTION OF THE DRAWINGS

FIG. 1A to FIG. 1C show a method for producing an elastic stamp according to one embodiment of the present invention.

FIG. 2A and FIG. 2B show a method for forming patterns on a surface of a sample according to an embodiment of the present invention.

FIG. 3 shows XPS energy distributions of the OTS self-assembled monolayer at different processing times of plasma treatment.

FIG. 4A shows the XPS energy distribution of the OTS self-assembled monolayer without plasma treatment.

FIG. 4B shows the XPS energy distribution of the OTS self-assembled monolayer with plasma treatment for 10 seconds.

FIG. 5 shows a plasma-induced modification carried out in selective areas of a sample according to one embodiment of the present invention.

FIG. 6A and FIG. 6B are SPEM images of the OTS molecule layer after the plasma-induced modification according to another embodiment of the present invention.

FIG. 7A is a SEM image of the OTS molecule layer after the plasma-induced modification according to another embodiment of the present invention.

FIG. 7B is a SKPM image of the OTS molecule layer after the plasma-induced modification according to another embodiment of the present invention.

FIG. 8 is an AFM image showing the OTS molecule during the self-assembled reaction.

FIG. 9 is a chart showing the relationship between the thickness of the OTS monolayer and the processing time of plasma treatment.

FIG. 10A is a diagram showing that the OTS molecule can adsorb APTMS molecule after plasma-induced modification according to another embodiment of the present invention.

FIG. 10B shows a multilayer structure of OTS/APTMS/gold nanoparticles according to another embodiment of the present invention.

FIG. 11 is a SEM image of the multilayer structure shown in FIG. 10B.

### DESCRIPTION OF THE PREFERRED EMBODIMENT

Reference will now be made in detail to specific embodiments of the invention. Examples of these embodiments are illustrated in the accompanying drawings. While the invention will be described in conjunction with these specific embodiments, it will be understood that such description is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well-known process operations and components are not described in detail in order not to unnecessarily obscure the present invention. While the drawings are illustrated in detail, it is appreciated that the quantity of the disclosed components may be more or less than that disclosed, except for instances expressly restricting the amount of the components. Wherever possible, the same or similar reference numbers are used in the drawings and the description to refer to the same or like parts.

The inventive concept of the present invention is to use plasma (e.g., an activated gas) to modify one or more selective (e.g., selected) areas of a surface of a sample. The modification can comprise, but is not limited to, one or more of surface activation, plasma polymerization, plasma deposition, plasma induced grafting, plasma etching, and the like. Due to plasma being an activated gas having excellent chemical reactivity and flow ability it is suitable for treating samples having different materials, shapes, and sizes, and it is capable of modifying only the surface of the sample while maintaining the internal properties of the sample. For example, the surface modification may comprise altering one or more of the reflective index, the hardness, and the functional group of the surface, and altering one or more of the capability of wetting, adhesion, coloring, compatibility to biologics, and passivating.

An embodiment of the present invention provides a method to modify one or more selective areas of a surface of a sample. The method comprises providing a sample, arranging a template on a surface of the sample, and providing a plasma to modify one or more selective areas of the surface of the sample, wherein the template is used as a mask to isolate the plasma. In other words, the embodiment chooses a kind of plasma according to the design requirement and employs the template to determine the area or areas of the surface to be modified, so that areas covered by the template can maintain one or more of the original function group, chemical composition, and property. Therefore, the modified areas and unmodified areas may have different properties, and patterns having different functions can be formed on the surface of the sample.

The above-mentioned template is arranged on the surface of the sample to construct at least a channel through which the plasma flows; hence the plasma contacts the surface, and the modification can be carried out. To construct the above-mentioned channel, the template may comprise one or more continuous or discrete relief structures. After the template is arranged on the surface of the sample, the plasma flows into an inlet and exits from an outlet of the channel. The inlet and outlet may be located at one or more of the top and the side of the template. Alternatively, the template may comprise a plurality of openings (through holes), whereby the plasma contacts the surface via the openings thus modifying the selective areas of the surface. It is projected that, according to another embodiment of the present invention, the above-mentioned relief structure(s) may be formed on the surface of the sample rather than the surface of the template, and the channel may be constructed after the template is attached to the surface of the sample.

Because the template functions as a mask to shield the plasma, it is preferably made of a material having good chemical resistance to the selected plasma for increasing its reliability after repeated usages. In addition, because rigid templates disadvantageously cannot completely be attached to the surface of the sample, and the plasma may penetrate through or around gaps between the template and the surface of the sample, the template of the embodiment is preferably made of an elastic material, such as PolyDiMethylSiloxane (PDMS); therefore, the template can be attached on the surface of the sample completely (e.g., flush at all locations) even though (e.g., to the extent that) the surface of the sample is a bit uneven, thus forming modified areas having superior resolution and preventing the sample from being damaged by the template.

In other embodiments of the present invention, the template may be made of polyurethanes, polyimides, or cross-linked Novolac resins in a condition that the feature size and the resolution are not strictly requested (e.g., specified or predetermined).

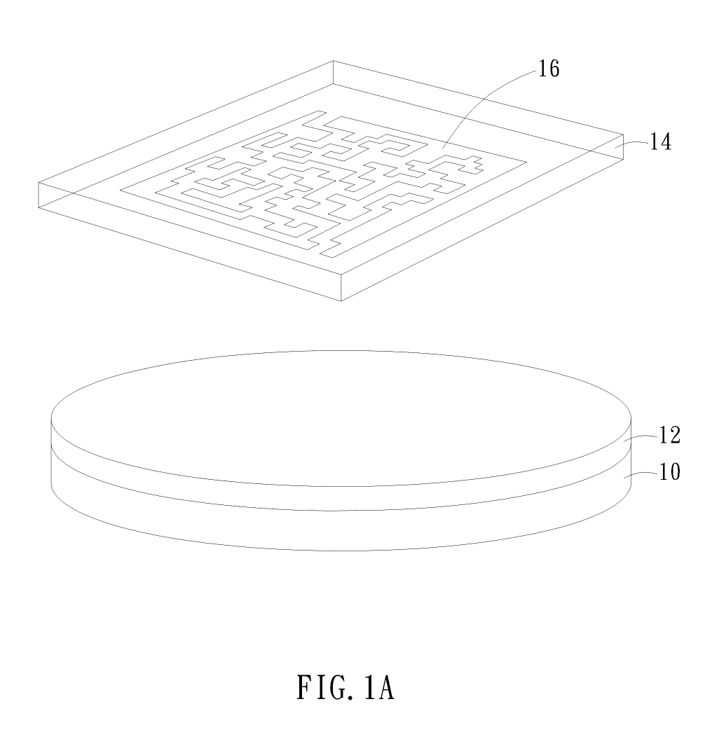

Another embodiment of the present invention provides a method for forming patterns. FIG. 1A to FIG. 1C show a method for forming an elastic stamp for forming the patterns according to another embodiment of the present invention. Referring to FIG. 1A, a 3-inch silicon wafer 10 is coated with photoresist 12 (for example, Microchem, product no. SU-8 2035). A conventional photolithography process may be used to transfer patterns 16 of a mask 14 to the photoresist 12. Referring to FIG. 1B, patterns 18 are formed on the developed photoresist 12′ to be used as a mold for manufacturing the elastic stamp later. After that, a primary polymer PDMS (SYLGARD, 18A) and a secondary polymer (SYLGARD, 184B) are uniformly mixed in a ratio of 10:1, and meanwhile the mixture (referred to as PDMS hereinafter) is placed into a vacuum chamber for degassing through a vacuum pump, thereby obtaining bubble-less PDMS liquid gel. The bubble-less PDMS liquid gel 20 is poured into the above-mentioned photoresist 12′ mold having patterns 18, and is then heated in an oven about 100° C. for 30 minutes to become an elastomer. A separation process is then performed to separate the PDMS elastomer and the photoresist 12′ mold. Referring to FIG. 1C, a PDMS elastic stamp 22 having patterns 18′ with a relief structure 24 is obtained. For making the separation process easier, a pretreatment step may be performed on the surface of the photoresist 12′ mold. For example, forming a monolayer on the surface of the photoresist 12′ mold makes it highly hydrophobic, such that the PDMS elastic stamp 22 can be easily separated with the assistance of alcohol.

After the elastic stamp 22 is produced, the embodiment of the present invention selects suitable plasma according to the designed needs. For example, by using the oxygen as the plasma source to treat a general polymer, a polar functional group may be formed on the surface of the polymer, and makes the polymer hydrophilic; in contrast, by using the fluorine as the plasma source to treat the polymer, the polymer is made hydrophobic. Because the embodiment of the present invention arranges the elastic stamp 22 to be completely attached to the surface of a sample, the plasma only contacts the areas of the surface exposed by the elastic stamp 22, and the other areas are isolated by the elastic stamp 22. Hence plasma-induced modifications are implemented in selective areas of the surface that the plasma contacts. A modified area is formed in selective area(s), and the other area(s) is unmodified area. Where the plasma modifies the surface of the sample through the relief structure 24 of the elastic stamp 22, and thus the modified area comprises the shape of the relief structure 24 of the elastic stamp 22.

In addition, the modified area and unmodified area may be treated to have different properties according to the requirements. A specific substance may be added to or interacted with the modified area or the unmodified area. The specific substance may comprise a molecule that can proceed with the self-assembly reaction. For example, immersing the sample into a solution comprising specific chemical or biological molecules or metal particles will result in the specific molecules or particles being selectively adsorbed in the modified area or the unmodified area by their interacting force, which comprises Van der Walls force, hydrogen bonding, Coulomb electrostatic force, dipole-dipole interaction, and the like. Hence a pattern having different functions in different areas can be obtained. Because the self-assembled molecule is to use a specific functional group to interact with a specific surface of the sample, the uniformity and selectivity can be highly satisfied, and consequently the pattern has better resolution. According to the present invention, the thickness of the self-assembled structure can be controlled by controlling the processing time of plasma treatment, and the self-assembly reaction is capable of treating a large quantity of integration of patterns.

Although the above-mentioned embodiment employs the conventional lithography to produce the photoresist 12′ mold, in other embodiments the photoresist 12′ mold can be produced by other methods such as electron beam lithography or focused ion beam lithography. Accordingly, the feature size of the mold determines the scale of the relief structure 24 of the elastic stamp 22. The scale of the embodiment may comprise micrometer, nanometer, centimeter, and other scales; hence the patterns of the present invention may comprise multiple feature sizes having different scales. In addition, the working area of the elastic stamp 22 can be adjusted for different application. For example, a bigger elastic stamp 22 is suitable for a larger area to decrease the time and cost for replicating patterns.

Moreover, in the above embodiment the relief structure 24 is located in the surface of the elastic stamp 22, but this should not be limited. If the PDMS liquid gel 20 is poured into the mold with a height smaller the height of the mold, perforated openings will be formed in the relief structure, and the plasma contacts and modifies the surface of the sample through the openings.

Furthermore, in the above embodiment the elastic stamp is made of PolyDiMethylSiloxane (PDMS), but in other embodiments it can be made of other elastic materials in a condition that the elastic stamp can be attached completely with the surface of the sample, thus forming modified area having superior resolution in selective areas, and preventing the surface of the sample from being damaged by the elastic stamp. More, the elastic stamp is preferably made of a material having good chemical resistance to the selected plasma, so that it has good reliability after repeated usages.

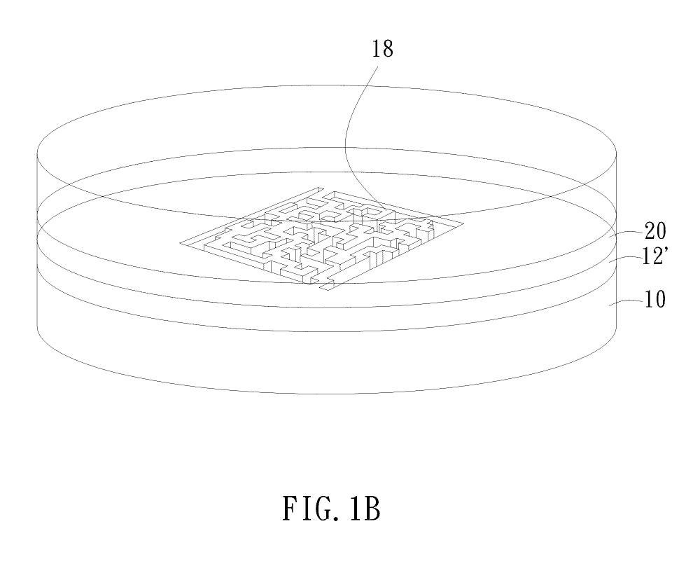

FIG. 2A and FIG. 2B show a method for forming patterns by forming a self-assembled monolayer (SAM) in a surface of a sample according to an embodiment of the present invention. In this embodiment, the elastic stamp 22 as described in the above embodiment can be used, and the feature size (line width) of the relief structure 24 of the elastic stamp 22 is about 5 micrometer.

First, a sample 30, for example, a silicon substrate, is provided. The surface of the silicon substrate may be naturally oxidized to form a silicon oxide layer in an environment having oxygen and water. Or, hydroxyl groups may be formed on the surface of the silicon substrate by treatment of plasma or sulfuric acid; the hydroxyl groups will be used later for forming a uniform self-assembled monolayer. In this exemplary embodiment, the silicon substrate is cleaned with acetone, alcohol, and deionized water in sequence. The cleaned silicon substrate is treated in a plasma chamber having condition power 12 W, 0.6 torr for 10 minutes with air as the plasma source, and the surface of the silicon substrate is activated by the air plasma. The activated silicon substrate is then immerged in 0.5 mM OctadecylTrichloroSilane (OTS, H₃C(CH₂)1₇SiCl₃, Aldrich, product no. 104817) solution with toluene as the solvent, resulting in that an OTS monolayer 32 is formed in the activated surface of the silicon substrate by self-assembled reaction between the OTS molecule and activated surface, as shown in FIG. 2A. The sample 30 is then cleaned by alcohol and deionized water in sequence. In the embodiment the sample 30 should not be limited to silicon substrate; in other embodiments, the sample 30 may comprise glass, indium tin oxide (ITO), or aluminum oxide substrate. Preferably, the sample 30 is capable of providing silane-based molecules to trigger the self-assembly reaction. The produced PDMS elastic stamp 22 may be cleaned by acetone, alcohol, and deionized water in sequence. The PDMS elastic stamp 22 is attached with the sample (silicon substrate) 30 completely and then placed in a plasma chamber and in which air is used as the plasma source under the conditions of 12 W, 0.6 torr for 3 minutes. The air plasma 33 enters and exits from via the inlet hole A and outlet hole B in the side of the elastic stamp 22, and is diffused to a channel 36 constructed by the elastic stamp 22 and the sample 30. The OTS monolayer 32 exposed by the channel 36 will be contacted with the air plasma 33, and its methyl groups will be modified to hydroxyl groups due to the high reactivity of air plasma 33. On the other hand, the OTS monolayer 32 covered by the PDMS elastic stamp 22 remains as (e.g., maintains) the methyl group, as shown in FIG. 2B.

In this embodiment, because the inlet and outlet holes A, B (FIG. 2A) are located at the side of the elastic stamp 22 (FIG. 2A), the pattern is opened at hole A′ and hole B′. If the inlet and outlet holes A, B are formed on the top of the elastic stamp 22 with the relief structure 24, the pattern will be a closed pattern. In addition, because the elastic stamp 22 is made of elastic, soft material, it can completely attach to the surface of the sample and protect the OTS monolayer 32.

After the plasma treatment is finished, the PDMS elastic stamp 22 is separated from the sample 30. The sample 30 is then cleaned by acetone, alcohol, and deionized water in sequence. Accordingly, the sample 30 with OTS monolayer 32′ having modified area 34 and unmodified area 34′ is obtained.

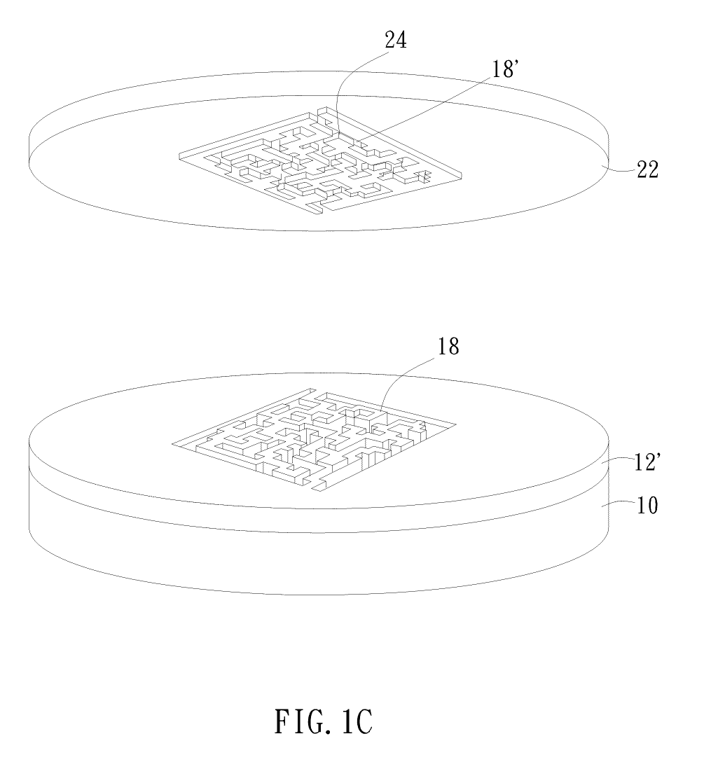

FIG. 3 shows x-ray photoelectron spectroscopy (XPS) inspections of the OTS monolayer at different processing times of the air plasma treatment. The binding energies of the internal electrons of carbon atoms on the surface of the OTS monolayer are measured, where curve a denotes the XPS energy distribution of the OTS monolayer without plasma treatment, and curves b, c, d, e respectively denote the XPS energy distribution of the OTS monolayer with air plasma treatment under the condition of 12 W, 0.6 torr for 1, 3, 5, and 10 seconds. The above XPS energy distribution curves show that longer processing times of the air plasma yield higher binding energies of the internal electrons of carbon atoms on the surface of the OTS monolayer. The measurements prove that the air plasma gradually modifies the surface of the OTS monolayer.

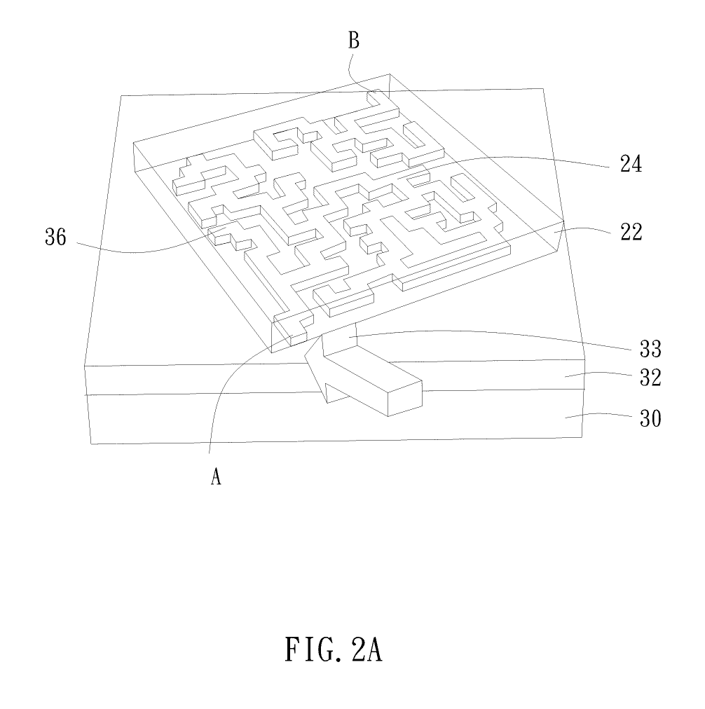

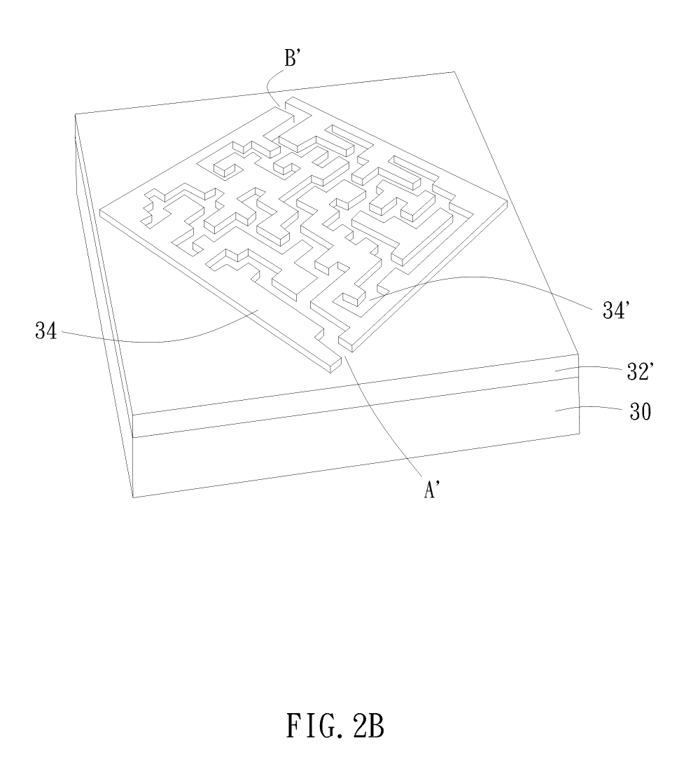

FIG. 4A and FIG. 4B respectively show XPS energy distributions of the internal electrons of the carbon atoms on the surface of the above-mentioned OTS monolayer without plasma treatment and with air plasma treatment for 10 seconds. The case without plasma treatment shows that only the C-C bond is analyzed; the case with air plasma treatment shows that C—O, C═O, and COOH bonds are analyzed in addition to the original C—C bond. This means that the surface of the OTS monolayer is modified to oxygen-containing groups by the oxygen-derived free radicals of the air plasma.

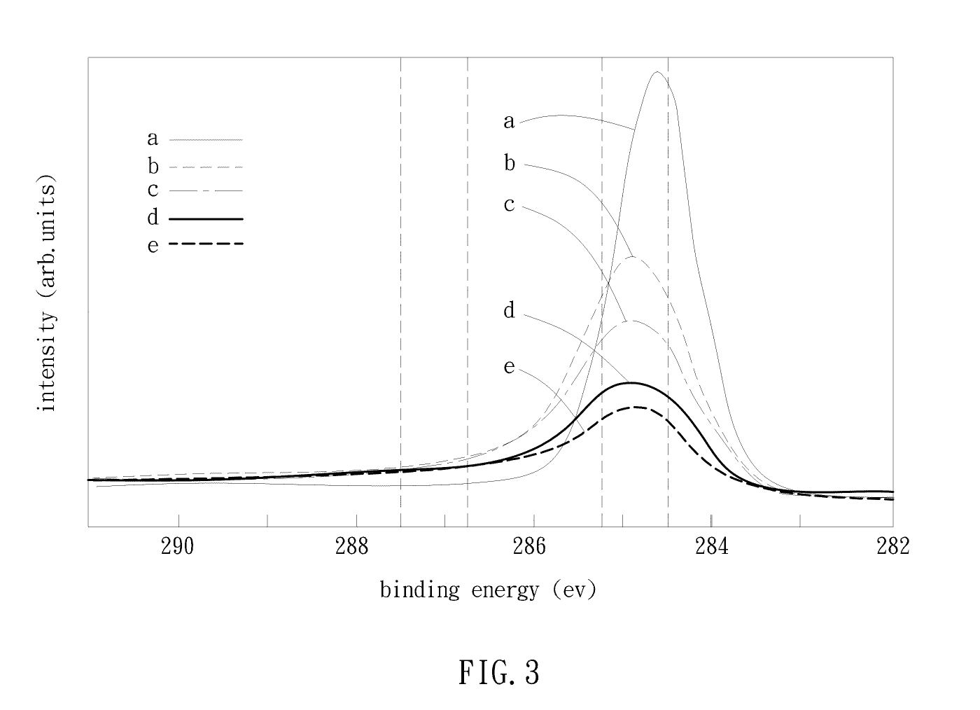

Referring to FIG. 5, the above experimental results show that the OTS monolayer 32′ of the surface of the sample 30 of the embodiment can be divided into two areas, namely, the unmodified area 34 and the modified area 34′. The methyl groups 37 remain on the OTS monolayer in the unmodified area 34; in contrast, the methyl group is replaced by hydroxyl group 38, carbonyl group 40, and/or carboxyl group 42 in the modified area 34′.

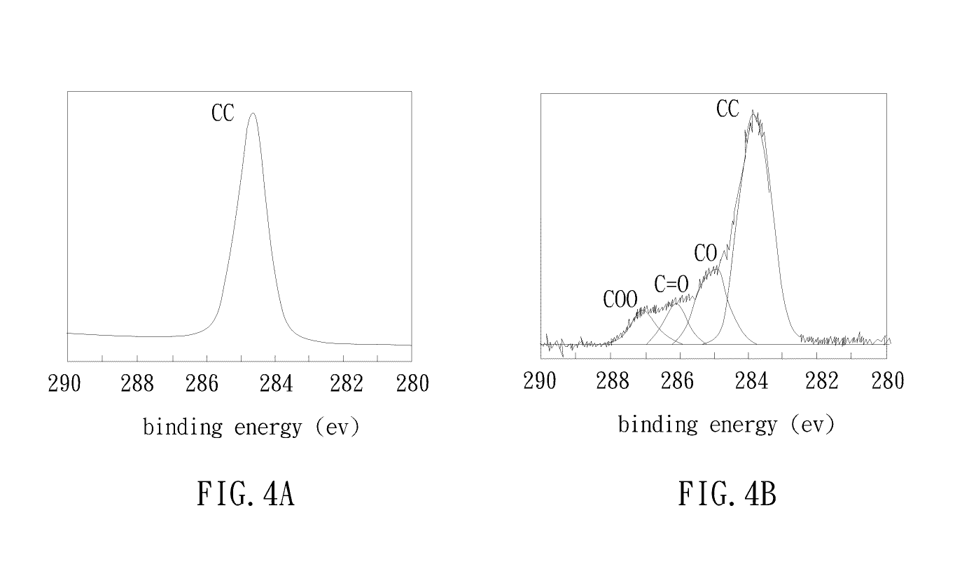

FIG. 6A and FIG. 6B show scanning photoemission spectromicroscopy (SPEM) measurements of the OTS monolayer 32′ of the sample 30 having unmodified area 34 and modified area 34′. The microscopic images were formed by collecting a characteristic core-level photoelectron signal while raster-scanning the sample relative to the focused soft X-ray beam. The contrast of the image reflects the intensity of the collected photoelectron signal. The measuring binding energy in FIG. 6A is set from 287.50 to 286.75 eV, which is about the binding energy level of C—O and C═O bonds. As shown in FIG. 6A, the intensity of the collected photoelectron signal in the modified area 34′ is stronger than that of the unmodified area 34. Because the unmodified area 34 does not include the C—O, C═O, and COOH bonds, the unmodified area 34 shows weak signal intensity in this binding energy range. In contrast, the measuring binding energy in FIG. 6B is set from 285.25 to 284.50 eV, which is about the binding energy level of a C—C bond. As shown in FIG. 6B, the intensity of the collected photoelectron signal in the unmodified area 34 is stronger than that of the modified area 34′; this is due to etching of the C—C bond of the OTS monolayer 32′ of the modified area 34′ by the plasma.

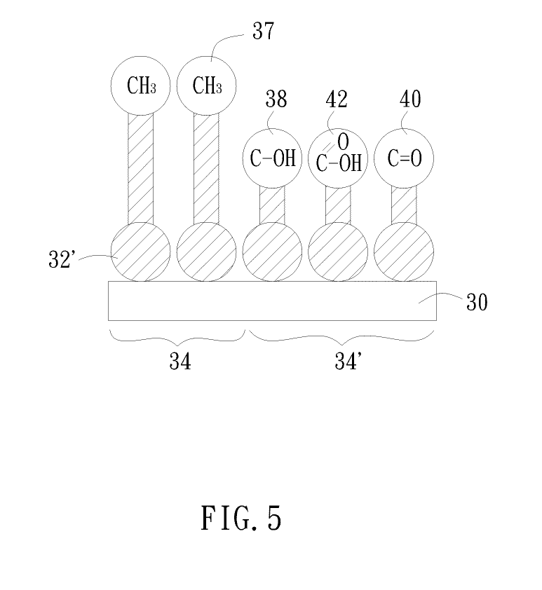

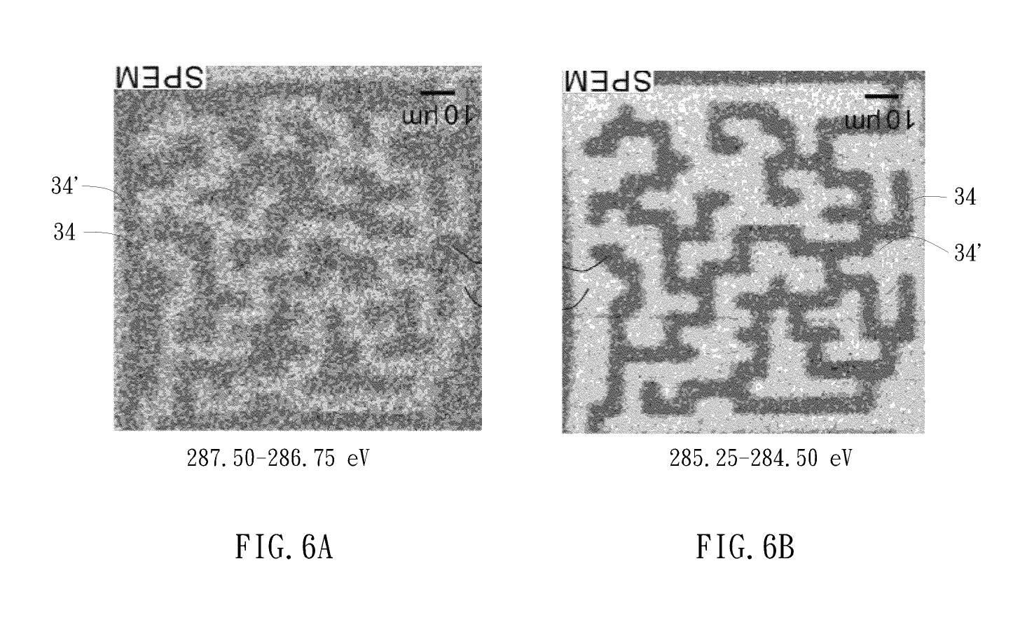

FIG. 7A and FIG. 7B respectively show the scanning electron microscope (e.g., SEM, Zeiss, Ultra 55) and scanning Kelvin probe microscope (e.g., SKPM, Seiko Instruments, SPA-300HV, using probe provided by MikroMasch, CSC37/Cr—Au) images of the OTS monolayer 32′ of the sample 30 having modified area 34′ and unmodified area 34. Because the modified area 34′ comprises hydroxyl, carbonyl, and/or carboxyl groups, its surface potential is lower than that of the unmodified area 34. Thus, the two figures show the modified area 34′ having a darker color than that of the unmodified area 34, wherein the modified area 34′ comprises the pattern of the relief structure 24 of the elastic stamp 22.

The above experiments prove that the combination of the plasma and the elastic stamp is capable of modifying the selective surface of the sample. In other embodiments, other gases or mixture of gases, such as oxygen or water vapor or oxygen-contained gas, can be or comprise a part of the plasma source. The plasma source should not be limited to the disclosed examples in interpreting the present invention.

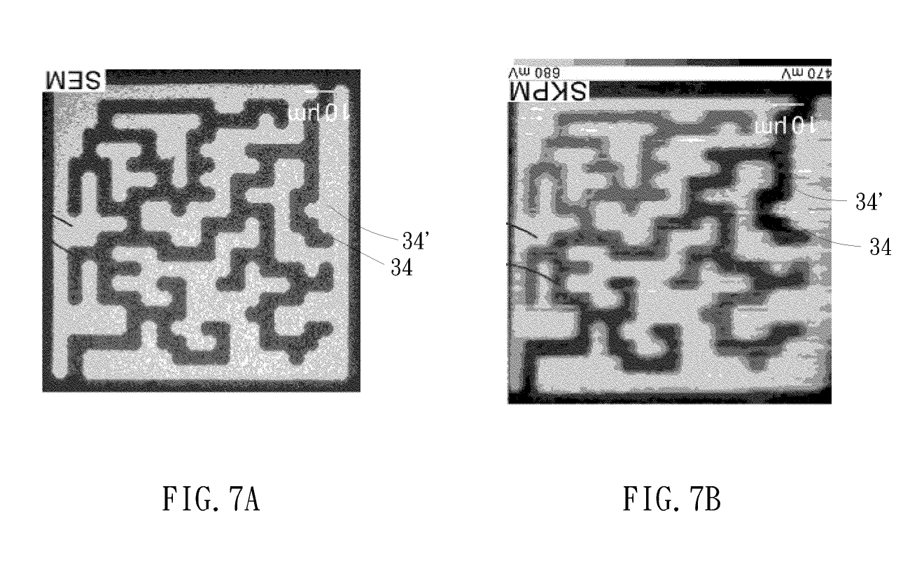

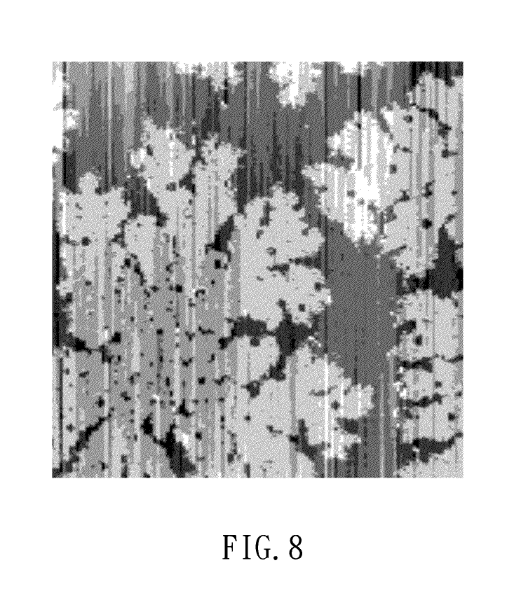

Referring to FIG. 8, the OTS molecules are shown formed as or into islands at the initial stage of the self-assembly reaction, and they gradually become a monolayer. FIG. 9 is a chart obtained from an atomic force microscope (e.g., AFM, Seiko Instruments, SPA-300HV, using a probe provided by MikroMasch, CSC37/Cr—Au coating Cr—Au, operated at the “tapping mode”), elucidating the relationship between the thickness (nm) of the OTS monolayer and the process time of plasma (second). As shown in FIG. 9, during a period in which the sample is treated by plasma for 0 to 27 seconds, the thickness of the OTS monolayer linearly decreases as the processing time of plasma increases; however, the OTS monolayer is kept at a constant thickness after prolonged plasma exposure. This is due to the OTS molecule being composed of carbon chains (C—C) and chlorosilane groups (—SiCl₃), wherein the carbon chains react with the air plasma to form water (H₂O) and carbon dioxide (CO₂), the water being removed out from the plasma vacuum chamber thus causing shorter chain lengths and a reduced (i.e., thinner) thickness of the OTS monolayer. The Si atom of the chlorosilane groups (—SiCl₃) connecting to the substrate will not react with the air plasma, so that the thickness of the OTS monolayer will not be decreased further after a period of plasma treatment. FIG. 9 not only shows that the carbon chain of the OTS monolayer will be gradually decomposed by the plasma but also shows that the properties such as the thickness of the OTS monolayer in selective areas can be controlled by controlling the processing time of plasma treatment.

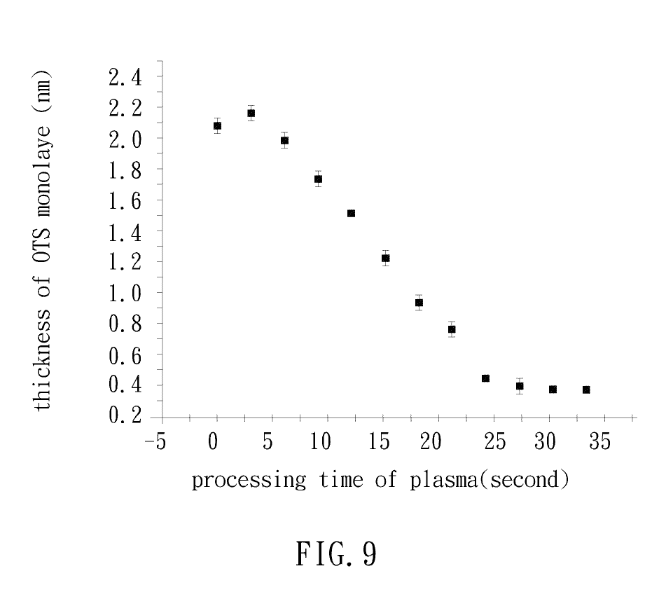

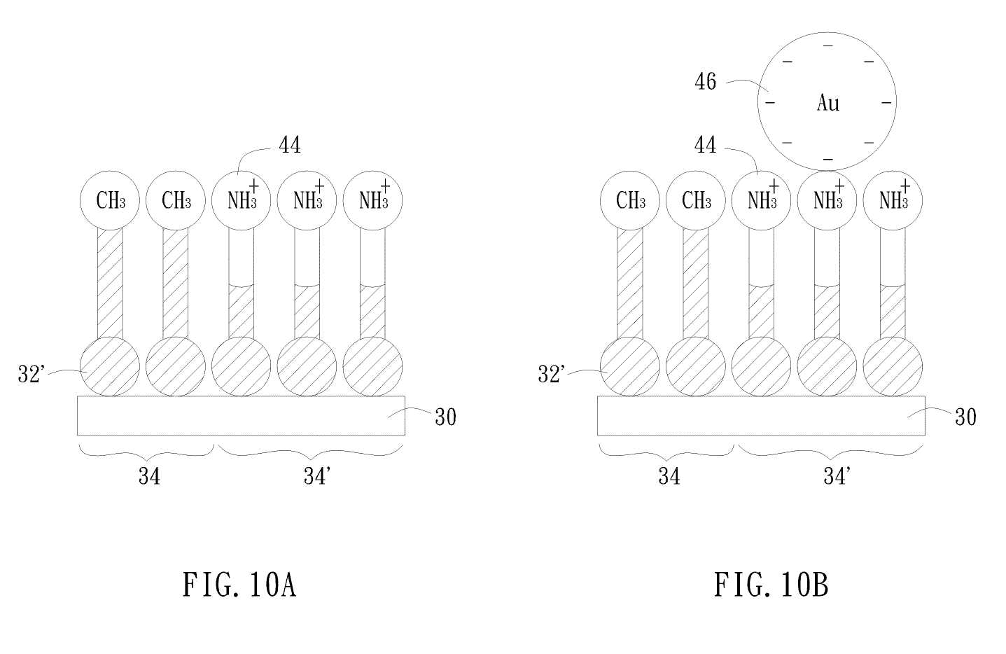

In addition, in this embodiment a self-assembled molecule may be further provided to selectively interact with a specific area of the surface of the sample 30. As an example, the sample 30 with modified OTS monolayer in selective areas is immersed in a 3-AminoPropylTriMethoxySilane (APTMS), 97 wt % solution for 24 hours. The APTMS (H₂N(CH₂)₃Si(OCH₃)₃) may be obtained from Aldrich, product no. 281778. Referring to FIG. 10A, because the modified area 34′ of the OTS monolayer 32′ comprises hydroxyl and carboxyl groups that are both hydroxyl-based groups, the APTMS molecule can be adsorbed at the terminal of the OTS molecule in the modified area 34′, and thus a APTMS molecule monolayer is formed on the OTS molecule monolayer; because the methyl group remains on the surface of the unmodified area 34, the APTMS molecule cannot be adsorbed on the surface of the unmodified area 34, and the APTMS self-assembled monolayer cannot be formed. The sample 30 may then be cleaned by deionized water, and thus a sample 30 having an OTS/APTMS dual layer patterned structure can be obtained. Because the surface of the OTS monolayer 32′ of the unmodified area 34 comprises methyl groups, the unmodified area 34 is hydrophobic. Because the surface of the APTMS molecule comprises polar groups, the modified area 34′ is hydrophilic.

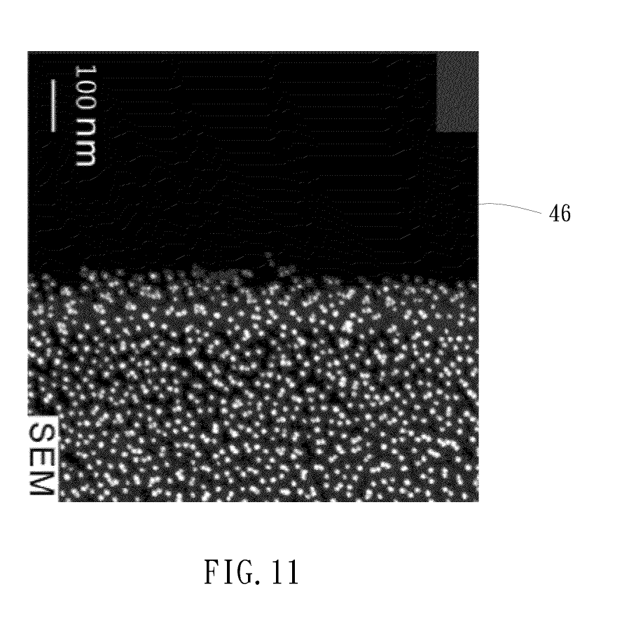

Further, the sample 30 being adsorbed with APTMS molecules 44 is immersed in an aqueous solution containing gold nanoparticles (for example, Sigma, product no. G1527, ca., 10 nm mean particle size) for 30 minutes. The terminal of the APTMS molecule 44 is an amino group (—NH₂), which will be protonated to a positively charged amino group (NH₃⁺) in the solution. The APTMS molecules 44 can be used to electrically attract the negatively charged gold nanoparticles 46, and thus a multilayer structure of gold nanoparticle/APTMS/OTS can be formed in the modified area 34′, as shown in FIG. 10B. FIG. 11 is a SEM image of the multilayer structure of gold nanoparticle/APTMS/OTS. The image shows a uniform distribution of the gold nanoparticles 46 in the multilayer structure.

In other embodiments, the gold nanoparticles 46 may comprise or consist of sizes in any part or all of the range from 1 to 1000 nm and/or may be uniformly distributed in a colloidal solution. For instance, the colloidal particles of the colloidal solution may comprise nanoscale and microscale gold particles. The embodiment employs the self-assembled monolayer (or multilayer) as the linker layer, the self-assembled monolayer being oppositely charged to the colloidal particles and the self-assembled monolayer electrically attracting the gold nanoparticles to form a uniform, two dimensional gold nanoparticle array. This embodiment can be applied in one or more of the fields of nanocatalyst, chemistry, biosensor, and nanophotonics.

In addition, the positively charged APTMS molecule can selectively adsorb one or more of other negatively charged particles such as (e.g., selected from) protein, antigen, antibody, ribonucleic acid, deoxyribonucleic acid, and the like.

According to the disclosed embodiments of the present invention, the number of the modification in selective areas of the surface of the sample is not intended to be limited; the sample can be repeatedly modified according to design requirements. The generated pattern may comprise multilayer structure(s). For precisely positioning the PDMS elastic stamp on the sample, markers may be formed on the sample, and the PDMS elastic stamp and a photo camera may be used to check the markers before positioning.

Although specific embodiments have been illustrated and described, it will be appreciated by those skilled in the art that various modifications may be made without departing from the scope of the present invention, which is intended to be limited solely by the appended claims.

What is claimed is:

1. A method for modifying a surface in selective areas, comprising:
providing a sample having said surface;
providing a template attached to said surface of said sample; and
contacting and modifying the selective areas of said surface with a plasma using said template to selectively isolate said plasma.

2. The method as recited in claim 1, wherein a channel is formed by way of said template being attached to said surface, and said plasma flows through said channel and modifies the selective areas of said surface.

3. The method as recited in claim 2, wherein said template comprises a relief structure, said relief structure and said surface of said sample forming said channel as a consequence of said template being attached to said surface.

4. The method as recited in claim 2, wherein said sample comprises a relief structure, said relief structure and said template forming said channel by way of said template being attached to said surface.

5. The method as recited in claim 2, wherein the side of said template comprises at least one hole as an entrance of said plasma.

6. The method as recited in claim 2, wherein the top of said template comprises at least one hole as an entrance of said plasma.

7. The method as recited in claim 1, wherein said template comprises at least one opening, and said plasma contacts and modifies the selective areas of said surface through said at least one opening.

8. The method as recited in claim 1, wherein said template is made of a material chemically resistant to said plasma.

9. The method as recited in claim 1, wherein said template is made of an elastic material.

10. The method as recited in claim 9, wherein said elastic material comprises PolyDiMethylSiloxane.

11. A method for forming patterns, comprising:
providing a sample;
providing an elastic stamp having a relief structure, said elastic stamp being attached to a surface of said sample; and
selectively contacting and modifying said surface with a plasma by using said elastic stamp to selectively isolate said plasma, thereby forming a modified area and an unmodified area on said surface;
wherein said plasma flows through said relief structure and modifies said surface, and thus said modified area comprises patterns of said relief structure.

12. The method as recited in claim 11, wherein said elastic stamp is made of a material having chemical resistance to said plasma.

13. The method as recited in claim 12, wherein said elastic stamp is made of PolyDiMethylSiloxane.

14. The method as recited in claim 11, wherein said relief structure is located on a surface of said elastic stamp.

15. The method as recited in claim 11, wherein said relief structure comprises at least one opening perforated to said elastic stamp.

16. The method as recited in claim 11, wherein said relief structure comprises microscale relief structure.

17. The method as recited in claim 11, wherein said relief structure comprises nanoscale relief structure.

18. The method as recited in claim 11, further comprising providing a specific substance to selectively interact in a specific area of said surface of said sample.

19. The method as recited in claim 18, wherein said sample is immersed in a solution containing said specific substance.

20. The method as recited in claim 18, wherein said specific substance comprises a molecule proceeding to self-assembled reaction in said specific area.

21. The method as recited in claim 18, wherein said specific area is said modified area.

22. The method as recited in claim 18, wherein said specific area is said unmodified area.

23. A method for forming patterns, comprising:
providing a sample;
attaching an elastic stamp having a relief structure to a surface of said sample;
providing a plasma to selectively contact and modify said surface by using said elastic stamp to selectively isolate said plasma, thereby forming a modified area and an unmodified area on said surface;
providing a self-assembled molecule to selectively interact with a specific area of said surface of said sample; and
immersing said sample in a solution containing a substance, said substance selectively interacting with said self-assembled molecule.

24. The method as recited in claim 23, wherein said specific area comprises a hydroxyl terminal group.

25. The method as recited in claim 24, wherein said self-assembled molecule comprises a silane.

26. The method as recited in claim 23, wherein said self-assembled molecule comprises a positively charged functional group at the terminal.

27. The method as recited in claim 26, wherein said positively charged functional group comprises an amino-group.

28. The method as recited in claim 26, wherein said substance is negatively charged.

29. The method as recited in claim 28, wherein said substance comprises a metal particle.

30. The method as recited in claim 29, wherein said metal particle comprises a colloidal gold nanoparticle.

31. The method as recited in claim 28, wherein said substance comprises a biological molecule.

32. The method as recited in claim 31, wherein said biological molecule comprises one or more of protein, antigen, antibody, ribonucleic acid, and deoxyribonucleic acid.

33. The method as recited in claim 23, wherein said surface of said sample comprises a methyl terminal group.

34. The method as recited in claim 33, wherein said surface of said sample comprises a monolayer of OctadecylTrichloroSilane (OTS).

35. The method as recited in claim 33, wherein an oxygen-containing gas is used as the plasma source of said plasma.

36. The method as recited in claim 35, wherein said oxygen-containing gas comprises one or more of air, oxygen, and water vapor.

37. The method as recited in claim 35, wherein said modified area comprises a hydroxyl group.

38. The method as recited in claim 37, wherein said specific area is said modified area, and said self-assembled molecule comprises a silane.

39. The method as recited in claim 38, wherein said self-assembled molecule comprises AminoPropylTriMethoxySilane.

40. The method as recited in claim 39, wherein said substance comprises a metal particle.

41. The method as recited in claim 40, wherein said metal particle comprises a colloidal gold nanoparticle.

42. The method as recited in claim 23, wherein said elastic stamp comprises PolyDiMethylSiloxane.
